(19) United States
(12) Patent Application Publication
(10) Pub. No.: US 2009/0301813 A1
(43) Pub. Date: Dec. 10, 2009

(54) ELEVATOR WORK PLATFORM ASSEMBLY

(76) Inventors: Annie CHANTELOIS, St-Lambert (CA); Frederick LABBE, St-Hubert (CA)

Correspondence Address: FRASER CLEMENS MARTIN & MILLER LLC, 28366 KENSINGTON LANE, PERRYSBURG, OH, 43551, US

(21) Appl. No.: 12/480,147

(22) Filed: Jun. 8, 2009

Related U.S. Application Data
(60) Provisional application No. 61/059,799, filed on Jun. 8, 2008.

(51) Int. Cl. E06C 5/04; E04G 1/22; E06C 5/32

(52) U.S. Cl. 182/64.1

(57) ABSTRACT

The elevator work platform assembly comprises a base movable over ground, an intermediate platform, a first stairway pivotally linked to the base and the intermediate platform and leading from one to the other, a work platform, a second stairway pivotally linked to the intermediate platform and the work platform and leading from one to the other, a linkage pivotally linked to the base and the first and second stairways, and an actuator capable of actuating the linkage and first and second stairways to move the work platform between a collapsed position in which it is adjacent to the base and a deployed position in which it is located away from the base. The stairways have self-levelling steps to allow access to the work platform in all positions thereof between the collapsed and deployed positions.

### CROSS-REFERENCE DATA

The present application claims the priority of U.S. provisional patent application No. 61/059,799 filed on Jun. 8, 2008.

### FIELD OF THE INVENTION

The present invention relates to vertically movable work platforms, and more particularly to an elevator work platform assembly having a linkage that cooperates with retractable stairways to move a work platform vertically.

### BACKGROUND OF THE INVENTION

Work platforms are used to allow human workers to gain access to and work on areas of structures or vehicles which are located high over ground. Many such work platforms are movable over ground so as to allow the work platform to be moved underneath the area to which access is desired, after which the workers will use the platform to gain the necessary vertical height. Work platforms are advantageous over simple ladders since they provide a more user-friendly workspace for the workers; and they are also advantageous over scaffoldings since they are ready-to-use, not requiring parts to be assembled or attachment to the structure on which work is to be performed.

### SUMMARY OF THE INVENTION

The present invention relates to an elevator work platform assembly comprising:

a base movable over ground;

an elongated first stairway comprising a pair of first stairway parallelograms linked by a number of first stairway self-levelling steps, said first stairway defining a first stairway bottom end pivotally connected to said base, a first stairway top end opposite said bottom end and a first stairway intermediate portion between said first stairway top and bottom ends;

an elongated second stairway comprising a pair of second stairway parallelograms linked by a number of second stairway self-levelling steps, said second stairway defining a second stairway bottom end pivotally connected to said first stairway top end, a second stairway top end opposite said second stairway bottom end and a second stairway intermediate portion between said second stairway top and bottom ends;

a vertically movable work platform pivotally connected at said second stairway top end, said first and second stairway parallelograms forcing said work platform to remain parallel to said base;

a linkage comprising:
a first arm member defining a first arm member bottom end movable along an elongated track carried by said base and pivotable about an axis parallel to said base and transversal to said track, said axis being movable along with said first arm member bottom end, a first arm member top end opposite said first arm member bottom end and a first arm member intermediate portion between said first arm member top and bottom ends;
a first pivot joint pivotally interconnecting said first arm member intermediate portion and said first stairway intermediate portion so as to form a scissor-type link between said first arm member and said first stairway;
a second arm member defining a second arm member bottom end pivotally connected to said first arm member top end, a second arm member top end opposite said bottom end and a second arm member intermediate portion between said second arm member top and bottom ends; and
a second pivot joint pivotally interconnecting said second stairway intermediate portion to said second arm member top end;
whereby said linkage and said first and second stairways are pivotally interconnected;
   and

a selectively powered actuator that actuates said pivotally interconnected linkage and first and second stairways to move said work platform with respect to said base between a collapsed position in which said work platform is located near said base and a deployed position in which said work platform is located away from said base, said first and second stairways allowing access to said work platform at all positions of said work platform between said collapsed and said deployed positions.

In one embodiment, said actuator is linked to and acts on said linkage.

In one embodiment, said actuator comprises a hydraulic cylinder having a first end pivotally attached to said first arm member intermediate portion and a second end pivotally attached to said second arm member intermediate portion, wherein the extraction of said cylinder forces said first and second arm members away from each other thereby concurrently forcing said first and second stairways to move said work platform towards said deployed position, and wherein the retraction of said cylinder forces said first and second arm members towards each other thereby concurrently forcing said first and second stairways to move said work platform towards said collapsed position.

In one embodiment, said elevator work platform assembly further comprises an intermediate platform pivotally connected to said first stairway top end and to said second stairway bottom end whereby said first stairway top end is pivotally connected to said second stairway bottom end, said intermediate platform facilitating the transition from said first stairway to said second stairway.

In one embodiment, said elevator work platform assembly further comprises an auxiliary parallelogram installed parallel to said pair of first stairway parallelograms, said auxiliary parallelogram defining an auxiliary parallelogram bottom end pivotally connected to said base, an auxiliary parallelogram top end pivotally connected to said intermediate platform and an auxiliary parallelogram intermediate portion between said auxiliary parallelogram top and bottom ends, said first pivot joint pivotally interconnecting said first arm member intermediate portion and said auxiliary parallelogram intermediate portion.

In one embodiment, said base defines first and second sides, said first and second arm members being generally laterally aligned with respect to said second stairway while said first stairway is generally laterally offset with respect to said first and second arm members and said second stairway.

In one embodiment, said linkage further comprises an auxiliary arm member integrally linked to said first arm member and defining an auxiliary arm member bottom end movable along said track and pivotable about said axis, and a top end pivotally linked to said first pivot joint, said auxiliary arm member being generally laterally aligned with respect to said first stairway.

In one embodiment, said first arm member comprises three integrally linked arms two of which are longer than the third, said second arm member comprises a pair of integrally linked arms of equal length and said auxiliary arm member comprises a pair of integrally linked arms of equal length than that of said third arm of said first aim member.

In one embodiment, said work platform comprises a first work platform portion pivotally attached to said second stairway and a second work platform portion pivotally attached to said first work platform portion so as to be selectively pivotable between an open, operative position in which it is generally parallel to said first work platform portion and a closed, inoperative position in which it is not parallel to said first work platform portion.

In one embodiment, cacti parallelogram of said pair of first stairway parallelograms comprises top and bottom stringers extending from said first stairway top end to said first stairway bottom end, said first pivot joint comprising a pair of first pivot joint plates that extend respectively between said top and bottom stringers of a corresponding one of said first stairway parallelograms and between said top and bottom stringers of said auxiliary parallelogram, with said first arm member being pivotally attached to said first pivot joint plates generally midway between said top and bottom stringers of said corresponding one of said first stairway parallelograms and of said auxiliary parallelogram; said first pivot joint further comprising a pair of auxiliary pivot joint plates that extend between respective said top and bottom stringers of said pair of first stairway parallelograms, with said auxiliary aim member being pivotally attached to said auxiliary pivot joint plates generally midway between said first stairway top and bottom stringers.

In one embodiment, each parallelogram of said pair of second stairway parallelograms comprises top and bottom stringers extending from said second stairway top end to said second stairway bottom end, said second pivot joint comprising a pair of second pivot joint plates that extend between said top and bottom stringers of a corresponding one of said pair of second stairway parallelograms, with said second arm member being pivotally attached to said second pivot joint plate generally midway between said second stairway top and bottom stringers.

### DESCRIPTION OF THE DRAWINGS

In the annexed drawings:

FIG. 1 is a perspective view, from the left-hand side and from the rear, of an elevator work platform assembly according to the present invention, with the work platform being in its deployed position and with the second work platform portion being in its horizontal, operative position;

FIG. 2 is an enlarged partial perspective view, from the right-hand side and from the rear, of the first and second stairways, the linkage, the hydraulic cylinder, the intermediate platform and the work platform of the elevator work platform assembly of FIG. 1, with the steps removed from the stairways and the boards removed from the platforms for clarity purposes;

FIG. 3 is an enlarged partly broken perspective view, from the right-hand side and from the front, of the first and second stairways, the linkage, the hydraulic cylinder, the intermediate platform and the work platform of the elevator work platform assembly of FIG. 2;

FIG. 4 is a perspective view, from the right-hand-side and from the front, of the linkage and hydraulic cylinder of FIG. 3;

FIG. 5 is a perspective view, from the left-hand side and from the front, of the elevator work platform assembly with the work platform in its collapsed position and with the second work platform portion being pivoted vertically into its inoperative position;

FIG. 6 is a schematic view of the hydraulic circuit of the elevator platform assembly of the present invention; and

FIG. 7 is a view similar to FIG. 1, but with the second work platform portion being pivoted vertically into its inoperative position.

### DETAILED DESCRIPTION OF THE EMBODIMENTS

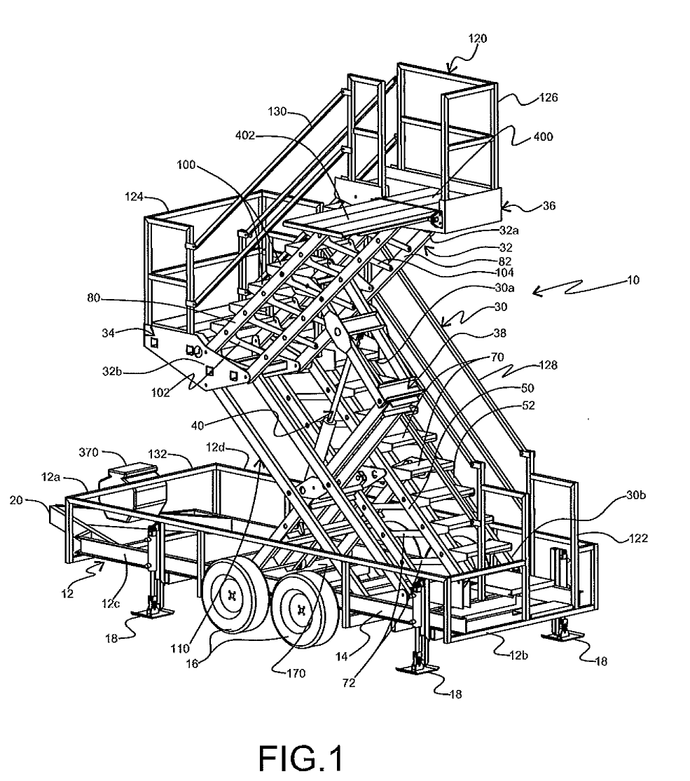

FIG. 1 shows an elevator work platform assembly 10 according to the present invention that comprises a base 12 movable over ground. Base 12 is shown in the drawings as being a trailer-type base, but it is understood that other types of movable or fixed bases would also be acceptable. Base 12 defines front and rear ends 12a, 12b and first and second sides 12c, 12d. Base 12 comprises a framework 14 carried over ground by wheels 16. Retractable stabilizing feet 18 are installed on framework 14 and may be deployed to stabilize base 12. Hydraulic or crank means (not shown) could optionally be used to control the deployment and retraction of feet 18. A hitch 20 is provided at base front end 12a to allow base 12 to be attached to and pulled by a vehicle.

Elevator work platform assembly 10 also comprises an elongated first stairway 30 defining top and bottom ends 30a, 30b and an intermediate portion therebetween, an elongated second stairway 32 defining top and bottom ends 32a, 32b and an intermediate portion therebetween, an intermediate platform 34 facilitating access from first stairway 30 to second stairway 32, a work platform 36 at second stairway top end 32b, a linkage 38 allowing platforms 34, 36 and stairways 30, 32 to be moved vertically and an actuator 40 acting on linkage 38 therefor, as detailed hereinafter.

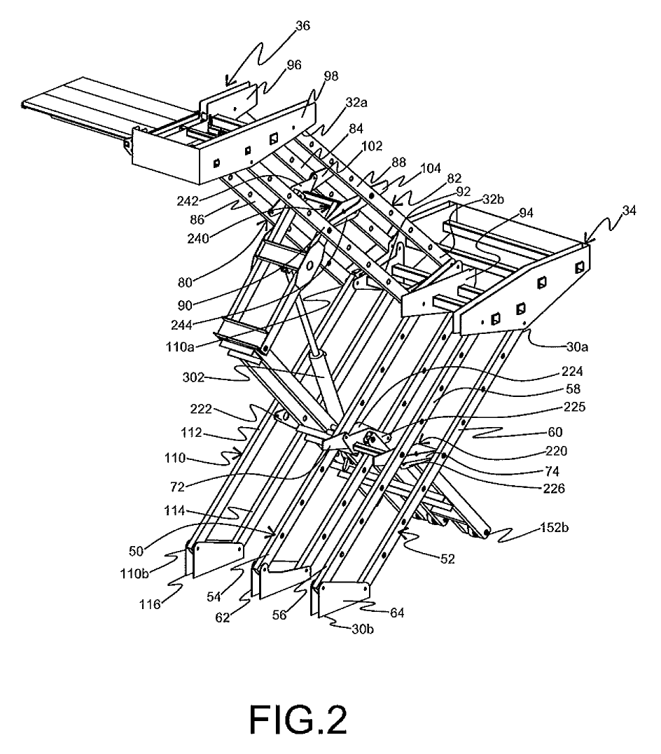

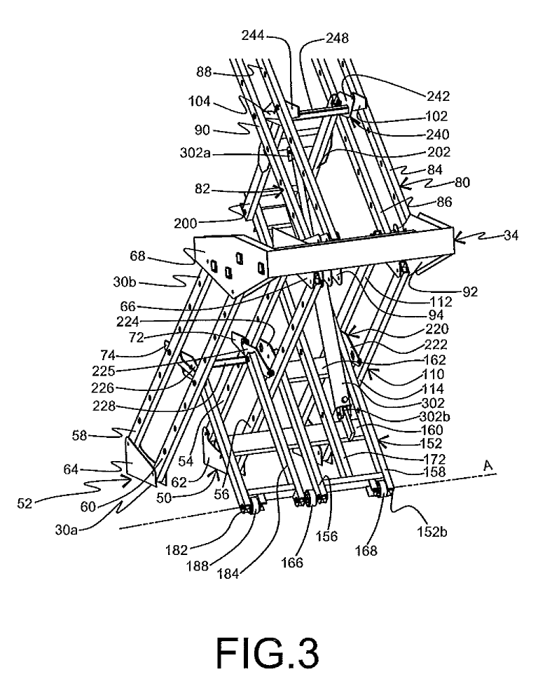

FIGS. 1-3 show that first stairway 30 comprises a pair of first stairway parallelograms 50, 52 each comprising top and bottom stringers, namely top and bottom stringers 54, 56 for one parallelogram 50 and top and bottom stringers 58, 60 for the other parallelogram 52 (FIGS. 2 and 3). The stringers of each parallelogram 50, 52 are pivotally attached in equally spaced apart fashion at their bottom end to base 12 by means of bottom parallelogram attachment plates 62, 64 and at their top end to intermediate platform 34 by means of top parallelogram attachment plates 66, 68. Consequently, stringers 54, 56, 58, 60 extend from first stairway top end 30a to first stairway bottom end 30b in parallel fashion to form parallelograms 50, 52 with base 12 and intermediate platform 34.

First stairway 30 further comprises a number of self-levelling steps 70 each fixedly attached between a pair of step plates 72, 74 at a leading end thereof near top stringers 54, 58. Each step plate 72 extends between and is pivotally attached to the stringers 54, 56 of one parallelogram 50 while each step plate 74 extends between and is pivotally attached to the stringers 58, 60 of the other parallelogram 52. The steps 70 are disposed parallel to base 12 such that, when intermediate platform 34 moves vertically, steps 70 remain parallel to base 12 and to platform 34 at all times as detailed hereinafter: this is why steps 70 are referred to as being self-levelling herein,

Second stairway 32 comprises a pair of second stairway parallelograms 80, 82 each comprising top and bottom stringers, namely top and bottom stringers 84, 86 for one parallelogram 80 and top and bottom stringers 88, 90 for the other parallelogram 82 (FIGS. 2 and 3). The stringers of each parallelogram 80, 82 are pivotally attached in equally spaced-apart fashion at their bottom end to intermediate platform 34 by means of bottom parallelogram attachment plates 92, 94 and at their top end to work platform 36 by means of top parallelogram attachment plates 96, 98. Stringers 84, 86, 88, 90 thus extend from second stairway top end 32a to second stairway bottom end 32b in parallel fashion to form parallelograms 80, 82 with intermediate platform 34 and work platform 36.

Second stairway 32 further comprises a number of self-levelling steps 100 each fixedly attached between a pair of step plates 102, 104 at a leading end thereof near top stringers 84, 88. Each step plate 102 extends between and is pivotally attached to the stringers 84, 86 of one parallelogram 80 while each step plate 104 extends between and is pivotally attached to the stringers 88, 90 of the other parallelogram 82. The steps 100 are disposed parallel to base 12 such that, when platforms 34, 36 move vertically, steps 100 remain parallel to platforms 34, 36 at all times as detailed hereinafter: this is why steps 100 are referred to as being self-levelling herein.

Intermediate platform 34 is thus pivotally connected to first stairway top end 30a and to second stairway bottom end 32b whereby first stairway top end 30a can in fact be said to be pivotally connected to second stairway bottom end 32b, through the instrumentality of intermediate platform 34. Intermediate platform 34 facilitates the transition from first stairway 30 to second stairway 32 to anyone using stairways 30, 32. Moreover, intermediate platform 34 can be used as an auxiliary work platform. Intermediate platform 34 remains parallel to base 12 at all times due to its pivotal attachment to base 12 by means of first stairway parallelograms 50, 52.

Elevator work platform assembly also comprises an auxiliary parallelogram 110 installed parallel to the pair of first stairway parallelograms 50, 52 and defining top and bottom ends 110a, 110b. Auxiliary parallelogram 110 comprises parallel top and bottom stringers 112, 114 that are pivotally connected to base 12 by means of bottom auxiliary parallelogram attachment plates 116 at bottom end 110b and by means of attachment plates 92 to intermediate platform 34 at top end 110a.

Work platform 36 is pivotally connected at the second stairway top end 32a and remains parallel to intermediate work platform 34 due to its pivotal attachment to intermediate platform 34 by means of second stairway parallelograms 80, 82. As a consequence, work to platform 36 remains parallel to base 12 at all times also.

Elevator work platform assembly 10 comprises a handrail network 120 including a fixed base handrail section 122 which is fixedly attached to base 12; a fixed intermediate platform handrail section 124 which is fixedly attached to intermediate platform 34; a fixed work platform handrail section 126 which is fixedly attached to work platform 36; a pivotable first stairway handrail section 128 which is pivotally attached between base handrail section 122 and intermediate platform handrail section 124 over and along first stairway 30; and a pivotable second stairway handrail section 130 which is pivotally attached between intermediate platform handrail section 124 and work platform handrail section 126 over and along second stairway 32. A guardrail 132 extends around base 12 but is interrupted in facing register with the bottom steps of first stairway 30 to allow access thereto between two handrails of base handrail section 122.

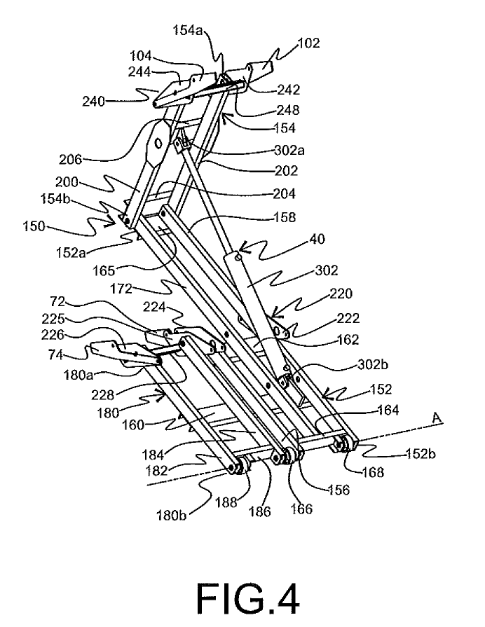

As shown in FIGS. 1-4, elevator work platform assembly 10 further comprises a linkage 150 comprising first and second arm members 152 and 154 that are pivotally linked to each other as detailed hereinafter.

First arm member 152 defines a first arm member top end 152a, a first arm member bottom end 152b opposite first arm member top end 152a and a first arm member intermediate portion between first arm member top and bottom ends 152a, 152b.

First arm member bottom end 152b is pivotable about an axis A which extends between the base first and second sides 12c, 12d as detailed hereinafter. More particularly, first aim member 152 comprises a pair of arms 156, 158 integrally linked by means of crossbars 160, 162, 164. The bottom end of each arm 156, 158 is equipped with a freely rotatable wheel 166, 168 which may roll on a longitudinal track 170 fixed to base 12 and longitudinally extending along base 12 between its front and rear ends 12a, 12b. First arm member bottom end 152b is thus pivotable about wheels 166, 168, i.e. along axis A which is movable along track 170. First arm member further comprises a reinforcement arm 172 linked to arms 156, 158 by means of crossbars 160, 162, 164 and further by means of an additional crossbar 165. Arm 158 and reinforcement arm 172 are of a same length and are longer than aim 156 and extend up to the first arm member top end 152a, while arm 156 extends up to the first aim member intermediate portion only.

Linkage 150 further comprises an auxiliary arm member 180 that extends parallel and adjacent to first arm member 152. Auxiliary aim member 180 comprises a pair of arms 182, 184 that are integrally linked to each other with a crossbar 186 and that are further integrally linked to arms 156, 158, 172 of first arm member 152 by means of crossbar 160. Crossbar 160 extends from first arm member 152 to auxiliary arm member 180. Auxiliary arm member 180 defines auxiliary arm member top and bottom end 180a, 180b. Wheel 166 is partly carried by the bottom end of arm 184, while an auxiliary wheel 188 is carried by the bottom end of arm 182. Auxiliary arm member 180 consequently moves integrally with first arm member 152 along track 170 and is also pivotable about the axis A mentioned hereinabove.

Second aim member 154 has a pair of arms 200, 202 integrally linked by crossbars 204, 206 and defines opposite top and bottom ends 154a, 154b with second arm member bottom end 154b being pivotally connected to first aim member top end 152a. More particularly, the top ends of long arms 158, 172 of first arm member 152 are respectively pivotally connected to the bottom ends of arms 202, 200 of second arm member 154.

Linkage 150 also comprises a first pivot joint 220 pivotally interconnecting the intermediate portion of first arm member 152 and the intermediate portion of first stairway 30 so as to form a scissor-type link between first arm member 152 and first stairway 30. More particularly, first pivot joint 220 comprises a pair of first pivot joint plates 222, 224 that each extend between and are pivotally attached to respective top and bottom stringers 112, 114 and 54, 56 of the auxiliary parallelogram 110 and of the first stairway parallelogram 50. First arm member 152 is more particularly pivotally attached generally centrally on first pivot joint plates 222, 224, that is to say approximately midway between top and bottom stringers 112, 114 and 54, 56. First pivot joint 220 also comprises a pair of auxiliary pivot joint plates 225, 226 that each extend between respective top and bottom stringers 54, 56 and 58, 60 of first stairway parallelograms 50, 52. More particularly, first arm member 152 is pivotally attached generally centrally on auxiliary pivot joint plates 225, 226, that is to say approximately midway between first stairway parallelograms top and bottom stringers 54, 56 and 58, 60. As seen in FIGS. 2-3, auxiliary pivot joint plates 225, 226 extend along and are adjacent to step plates 72, 74 and may be fixedly attached thereto, e.g. welded.

First pivot joint 220 comprises pivot bolts each pivotally linking first arm member 152 to respective first and or auxiliary pivot joint plates 222, 224, 225, 226. A reinforcement rod 228 extends between and is fixedly attached to auxiliary pivot joint plates 225, 226.

Linkage 150 further comprises a second pivot joint 240 pivotally interconnecting the intermediate portion of second stairway 32 to second arm member top end 154a. Second pivot joint 240 also comprises a pair of second pivot joint plates 242, 244 that each extend between respective top and bottom stringers 84, 86 and 88, 90 of second stairway parallelograms 80, 82. More particularly, second arm member 154 is pivotally attached generally centrally on second pivot joint plates 242, 244, that is to say approximately midway between second stairway parallelograms top and bottom stringers 84, 86 and 88, 90. As seen in FIGS. 2-3, second pivot joint plates 242, 244 extend along and are adjacent to step plates 102, 104 and may be fixedly attached thereto, e.g. welded.

Second pivot joint 240 comprises pivot bolts each pivotally linking second arm member 154 to respective second pivot joint plates 242, 244. A reinforcement rod 248 extends between and is fixedly attached to second pivot joint plates 242, 244.

First and second arm members 152, 154 could alternately be pivotally attached at other positions on first and second stairways 30, 32, respectively. For example, first and second arm members could be pivotally attached directly to the top or bottom stringers instead of using pivot joint plates that extend between the top and bottom stringers of first and second stairways 30, 32. However, it has been found that better results could be achieved by using pivot joint plates 222, 224, 225, 226, 242, 244 to attach arm members 152, 154 midway between the respective top and bottom stringers of first and second stairways 30, 32.

In any event, linkage 150 is pivotally interconnected to said first and second stairways 30, 32.

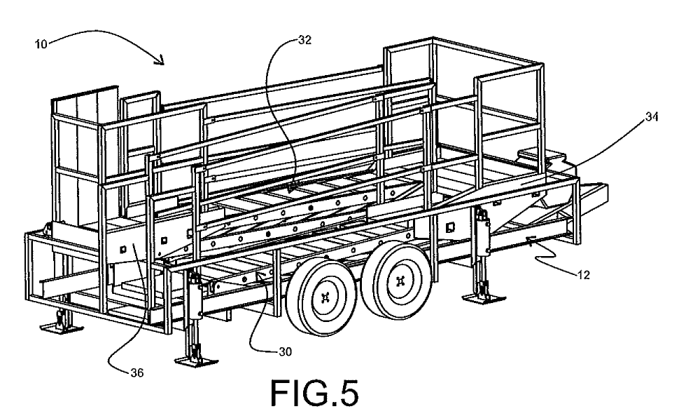

As mentioned hereinabove, elevator work platform assembly 10 also comprises a selectively powered actuator 40 that actuates the pivotally interconnected linkage 150 and first and second stairways 30, 32 to move work platform 36 with respect to base 12 between a collapsed position in which work platform 36 is located near base 12 (FIG. 5) and a deployed position in which work platform 36 is located away from base 12 (FIG. 1). More specifically, actuator 40 is linked to and acts on linkage 150 and comprises a hydraulic cylinder 302 which is attached at its top end 302a to the intermediate portion of second arm member 154 and more particularly to crossbar 206; and at its bottom end 302b to the intermediate portion of first arm member 152 and more particularly to crossbar 160.

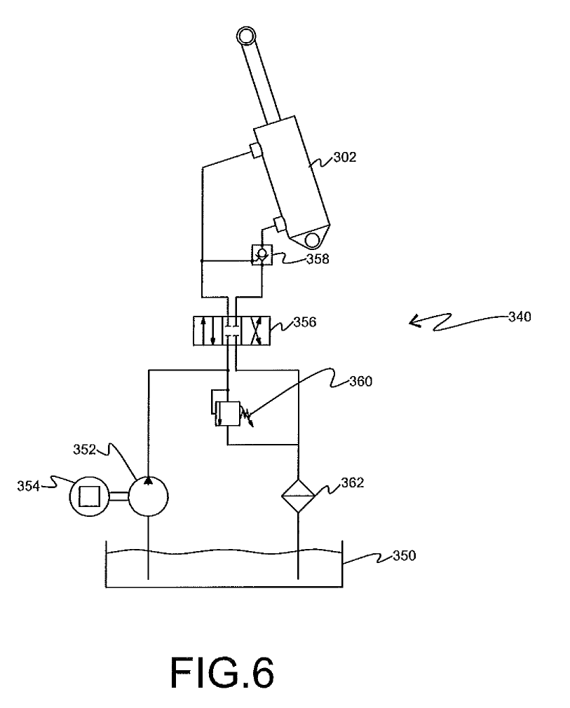

As schematically shown in FIG. 6, elevator work platform assembly 10 has a hydraulic circuit 340 that comprises a hydraulic fluid tank 350 from which a fluid pump 352 draws fluid, e.g. oil. Pump 352 is powered by an engine 354. A two-way control valve 356 allows fluid from pump 352 to be selectively fed to or retrieved from hydraulic cylinder 302 for controlled extraction or retraction of cylinder 302. Circuit 340 also comprises a pilot-operated security check valve 358 to allow cylinder 302 to retract only if it receives a fluid pressure from control valve 356, to prevent accidental, involuntary retraction of cylinder 302 which would result in the work platform 36 falling suddenly. A pressure control valve 360 is provided on circuit 340 to control the maximum fluid pressure in circuit 340 required for standard operation of elevator work platform assembly 36. A fluid filter 362 is provided near the fluid outlet leading the fluid back into tank 350. Some of the elements of circuit 340, such as engine 354, are housed in a housing 370 carried by base 12 and shown in FIG. 1. Otherwise, most elements of hydraulic circuit 340, including fluid pipes and other elements schematically shown in FIG. 6, have been omitted from FIGS. 1-5 and 7 for clarity purposes.

In use, through the selective controlled extraction or retraction of hydraulic cylinder 302, work platform 36 may be moved between its deployed and collapsed positions. More particularly, as hydraulic cylinder 302 is extracted, it will push on both first and second arm members 152, 154, forcing them apart. By their attachment to first and second stairways 30, 32, this movement of first and second arm members 152, 154 will also force first and second stairways 30, 32 apart. The combination of the attachment of first stairway bottom end 30b and auxiliary parallelogram bottom end 110b to base 12 and of the pivotal/rolling engagement of first arm member bottom end 152b and auxiliary arm member bottom end 180b on base 12 allows the linkage 150 and first and second stairway 30, 32 deployment; and as a consequence, the elevation of work platform 36 towards its deployed position.

Inversely, the retraction of cylinder 302 forces first and second arm members 152, 154 towards each other thereby moving work platform 36 towards its collapsed position.

The geometry of linkage 150 and first and second stairway 30, 32 and their respective attachments through pivot joints 220, 240 allows for work platform 36 and intermediate platform 34 to remain parallel to base 12 at all times. Also, the pivotal attachment of steps 70 and 100 to respective first and second stairway parallelograms 50, 52 and 80, 82 by means of respective step plates 72, 74 and 102, 104 allows for steps 70, 100 to also remain parallel to base 12 at all times. Consequently, first and second stairways 30, 32 allow access to work platform 36 at all positions of work platform 36 between its collapsed and deployed positions.

Of course, base 12 should preferably be installed horizontally over ground for work platform 36, intermediate platform 34 and steps 70, 100 to all be horizontal. Stabilizing feet 18 may be adjusted to compensate some terrain irregularities or angular deviations with respect to a horizontal plane.

It will be noted that auxiliary arm member 180 and auxiliary parallelogram 110 are not strictly essential. Their purpose is of course to allow use of materials in elevator work platform assembly 10 which are not as rigid as would otherwise be required. First and second arm members 152, 154 are generally laterally aligned with respect to second stairway 32 and partly support same through first pivot joint plates 222, 224 and 242, 244. This also allows linkage 150 to be located entirely underneath second stairway 32, thus being mostly concealed when work platform 36 is it its collapsed position as shown in FIG. 5. First stairway 30, on the other hand, is generally laterally offset with respect to first and second arm members 152, 154 and second stairway 32, while auxiliary arm member 180 is generally laterally aligned with respect to first stairway 30 in that it is located underneath first stairway 30, partly supporting same through first pivot joint plates 225, 226.

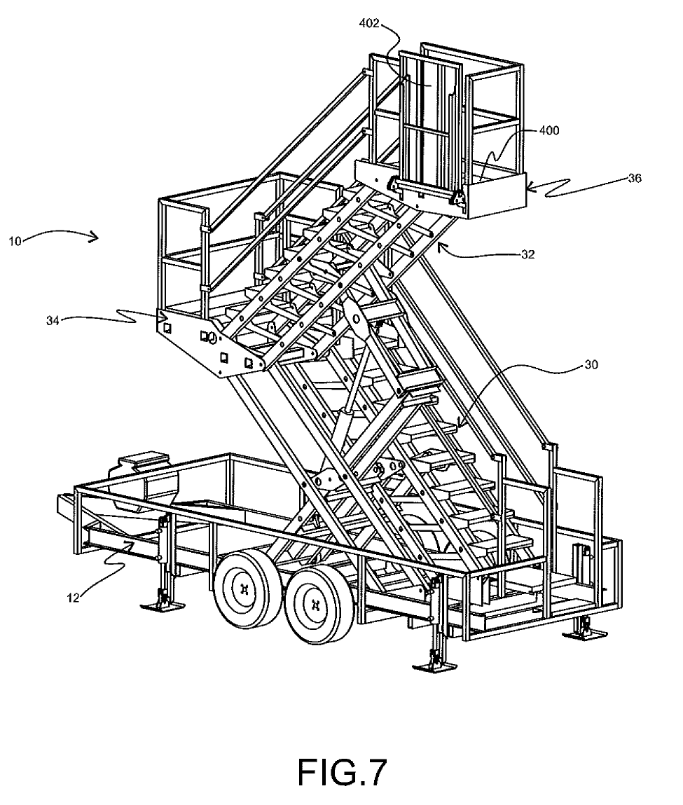

As shown in FIGS. 1 and 7, work platform 36 comprises a first work platform portion 400 pivotally attached to second stairway 32 and a second work platform portion 402 pivotally attached to first work platform portion 400 so as to be selectively pivotable between an open, operative position in which it is generally parallel to first work platform portion 400 (FIG. 1) and a closed, inoperative position in which it is generally perpendicular to first work platform portion 400 (FIG. 7).

One particular advantage of the elevator work platform assembly 10 of the present invention relies on the direct cooperation between linkage 150 and stairways 30, 32 to allow the vertical displacement of work platform 36; and this, through a simple mechanical structure which is easy to build and maintain in good working order. Other prior art devices do not offer such simple, sturdy and reliable solutions.

In one alternate embodiment of the present invention (not show), the elevator work platform assembly would include one or more additional platforms. More specifically, the elevator work platform assembly would include more than two platforms (i.e. the so-called intermediate and work platforms) and additional stairways extending between the first additional platform and the so-called work platform, and between each two successive additional platforms. A user could thus gain access to additional platforms each located higher than the preceding platform: the first additional platform would be accessed through a first additional stairway linking it to the work platform, the second additional platform would be accessed through a second additional stairway linking it to the first additional platform, and so on. These additional platforms would require either additional arms to be provided on the linkage to act on the additional stairways, or an additional distinct linkage altogether, and could adopt deployed and collapsed positions similarly to work platform 36 of the embodiment shown in the drawings.

1. An elevator work platform assembly comprising:
a base movable over ground;
an elongated first stairway comprising a pair of first stairway parallelograms linked by a number of first stairway self-levelling steps, said first stairway defining a first stairway bottom end pivotally connected to said base, a first stairway top end opposite said bottom end and a first stairway intermediate portion between said first stairway top and bottom ends;
an elongated second stairway comprising a pair of second stairway parallelograms linked by a number of second stairway self-levelling steps, said second stairway defining a second stairway bottom end pivotally connected to said first stairway top end, a second stairway top end opposite said second stairway bottom end and a second stairway intermediate portion between said second stairway top and bottom ends;
a vertically movable work platform pivotally connected at said second stairway top end, said first and second stairway parallelograms forcing said work platform to remain parallel to said base;
a linkage comprising:
a first arm member defining a first arm member bottom end movable along an elongated track carried by said base and pivotable about an axis parallel to said base and transversal to said track, said axis being movable along with said first arm member bottom end, a first arm member top end opposite said first arm member bottom end and a first arm member intermediate portion between said first arm member top and bottom ends;
a first pivot joint pivotally interconnecting said first arm member intermediate portion and said first stairway intermediate portion so as to form a scissor-type link between said first arm member and said first stairway;
a second arm member defining a second arm member bottom end pivotally connected to said first arm member top end, a second aim member top end opposite said bottom end and a second aim member intermediate portion between said second arm member top and bottom ends; and
a second pivot joint pivotally interconnecting said second stairway intermediate portion to said second arm member top end;
whereby said linkage and said first and second stairways are pivotally interconnected;
and
a selectively powered actuator that actuates said pivotally interconnected linkage and first and second stairways to move said work platform with respect to said base between a collapsed position in which said work platform is located near said base and a deployed position in which said work platform is located away from said base, said first and second stairways allowing access to said work platform at all positions of said work platform between said collapsed and said deployed positions.

2. An elevator work platform assembly as defined in claim 1, wherein said actuator is linked to and acts on said linkage.

3. An elevator work platform assembly as defined in claim 2, wherein said actuator comprises a hydraulic cylinder having a first end pivotally attached to said first arm member intermediate portion and a second end pivotally attached to said second arm member intermediate portion, wherein the extraction of said cylinder forces said first and second arm members away from each other thereby concurrently forcing said first and second stairways to move said work platform towards said deployed position, and wherein the retraction of said cylinder forces said first and second arm members towards each other thereby concurrently forcing said first and second stairways to move said work platform towards said collapsed position.

4. An elevator work platform assembly as defined in claim 2, further comprising an intermediate platform pivotally connected to said first stairway top end and to said second stairway bottom end whereby said first stairway top end is pivotally connected to said second stairway bottom end, said intermediate platform facilitating the transition from said first stairway to said second stairway.

5. An elevator work platform assembly as defined in claim 4, further comprising an auxiliary parallelogram installed parallel to said pair of first stairway parallelograms, said auxiliary parallelogram defining an auxiliary parallelogram bottom end pivotally connected to said base, an auxiliary parallelogram top end pivotally connected to said intermediate platform and an auxiliary parallelogram intermediate portion between said auxiliary parallelogram top and bottom ends, said first pivot joint pivotally interconnecting said first arm member intermediate portion and said auxiliary parallelogram intermediate portion.

6. An elevator work platform assembly as defined in claim 5, wherein said base defines first and second sides, said first and second arm members being generally laterally aligned with respect to said second stairway while said first stairway is generally laterally offset with respect to said first and second arm members and said second stairway.

7. An elevator work platform assembly as defined in claim 6, wherein said linkage further comprises an auxiliary arm member integrally linked to said first arm member and defining an auxiliary arm member bottom end movable along said track and pivotable about said axis, and a top end pivotally linked to said first pivot joint, said auxiliary arm member being generally laterally aligned with respect to said first stairway.

8. An elevator work platform assembly as defined in claim 7, wherein said first arm member comprises three integrally linked aims two of which are longer than the third, said second arm member comprises a pair of integrally linked arms of equal length and said auxiliary arm member comprises a pair of integrally linked arms of equal length than that of said third arm of said first arm member.

9. An elevator work platform assembly as defined in claim 1, wherein said work platform comprises a first work platform portion pivotally attached to said second stairway and a second work platform portion pivotally attached to said first work platform portion so as to be selectively pivotable between an open, operative position in which it is generally parallel to said first work platform portion and a closed, inoperative position in which it is not parallel to said first work platform portion.

10. An elevator work platform assembly as defined in claim 1, wherein cacti parallelogram of said pair of first stairway parallelograms comprises top and bottom stringers extending from said first stairway top end to said first stairway bottom end, said first pivot joint comprising at least one first pivot joint plate that extends between said top and bottom stringers of a corresponding one of said first stairway parallelograms, with said first arm member being pivotally attached to said first pivot joint plate generally midway between said first stairway top and bottom stringers.

11. An elevator work platform assembly as defined in claim 1, wherein each parallelogram of said pair of second stairway parallelograms comprises top and bottom stringers extending from said second stairway top end to said second stairway bottom end, said second pivot joint comprising at least one second pivot joint plate that extends between said top and bottom stringers of a corresponding one of said pair of second stairway parallelograms, with said second arm member being pivotally attached to said second pivot joint plate generally midway between said second stairway top and bottom stringers.

12. An elevator work platform assembly as defined in claim 7, wherein each parallelogram of said pair of first stairway parallelograms comprises top and bottom stringers extending from said first stairway top end to said first stairway bottom end, said first pivot joint comprising a pair of first pivot joint plates that extend respectively between said top and bottom stringers of a corresponding one of said first stairway parallelograms and between said top and bottom stringers of said auxiliary parallelogram, with said first arm member being pivotally attached to said first pivot joint plates generally midway between said top and bottom stringers of said corresponding one of said first stairway parallelograms and of said auxiliary parallelogram; said first pivot joint further comprising a pair of auxiliary pivot joint plates that extend between respective said top and bottom stringers of said pair of first stairway parallelograms, with said auxiliary arm member being pivotally attached to said auxiliary pivot joint plates generally midway between said first stairway top and bottom stringers.

13. An elevator work platform assembly as defined in claim 12, wherein each parallelogram of said pair of second stairway parallelograms comprises top and bottom stringers extending from said second stairway top end to said second stairway bottom end, said second pivot joint comprising a pair of second pivot joint plates that extend between said top and bottom stringers of a corresponding one of said pair of second stairway parallelograms, with said second arm member being pivotally attached to said second pivot joint plate generally midway between said second stairway top and bottom stringers.

14. An elevator work platform assembly as defined in claim 13, wherein said actuator comprises a hydraulic cylinder having a first end pivotally attached to said first arm member intermediate portion and a second end pivotally attached to said second arm member intermediate portion, wherein the extraction of said cylinder forces said first and second arm members away from each other thereby concurrently forcing said first and second stairways to move said work platform towards said deployed position, and wherein the retraction of said cylinder forces said first and second arm members towards each other thereby concurrently forcing said first and second stairways to move said work platform towards said collapsed position.
